(19) United States
(12) Patent Application Publication
(10) Pub. No.: US 2026/0038272 A1
(43) Pub. Date: Feb. 5, 2026

(54) SYSTEMS AND METHODS FOR A CAMERA THAT CAN DETECT A TRESPASSING ANIMAL OR UNAUTHORIZED PET ACTIVITY

(71) Applicant: Vivint LLC, Provo, UT (US)

(72) Inventors: Rongbin Lanny Lin, Provo, UT (US); Brandon Bunker, Provo, UT (US); Justin Tran, Provo, UT (US); Erik Swenson, Provo, UT (US); Conner Mickelson, Provo, UT (US)

(73) Assignee: Vivint LLC, Provo, UT (US)

(21) Appl. No.: 19/289,206

(22) Filed: Aug. 4, 2025

Related U.S. Application Data
(60) Provisional application No. 63/678,644, filed on Aug. 2, 2024.

(51) Int. Cl. G06V 20/52; A01K 11/00; A01K 15/02; A01M 29/10; A01M 29/16; G06V 40/10; H04N 7/18

(52) U.S. Cl. CPC G06V 20/52; A01K 11/006; A01K 15/021; A01M 29/10; A01M 29/16; G06V 40/10; H04N 7/183

(57) ABSTRACT

Presented herein are systems and methods for a camera that can detect a trespassing animal or unauthorized pet activity. A system can include a camera, light emitting device, sound emitting device, and processor. The camera can capture visual data of an area. The processor can be in communication with the camera, the sound emitting device, and the light emitting device. The processor can analyze the visual data to detect presence of an animal within the area; determine, based on the analysis, whether the animal is a trespassing animal; and responsive to determining that the animal is a trespassing animal or is pet engaging in the unauthorized activity activate the sound emitting device to emit a sound or the light emitting device to emit a light selected to deter the trespassing animal or pet engaging in the unauthorized activity.

### CROSS REFERENCE TO RELATED APPLICATION

This application is a claims priority to U.S. patent application Ser. No. 63/678,644, filed Aug. 2, 2024, the entire contents of which are hereby incorporated by reference as though fully set forth herein.

### TECHNICAL FIELD

This application generally relates to animal detection and deterrent systems through automated interventions.

### BACKGROUND

The presence of unauthorized or trespassing animals can pose significant challenges, ranging from safety risks to property damage and disruption of daily activities. Indoor and outdoor spaces often require effective management to prevent such animals from accessing restricted or sensitive areas. Traditional methods for controlling animal access can be either labor-intensive, involving human supervision, or can employ deterrents that are not always humane or effective across various animal types and behaviors. Moreover, the differentiation between unauthorized animals and permitted pets, particularly when pets engage in unexpected or undesired activities, presents a challenge that conventional approaches may not adequately address. There is a need for an automated solution that can dynamically recognize and mitigate the presence of unauthorized or trespassing animals in a humane and efficient manner.

### SUMMARY

The present disclosure provides a system for detecting and deterring unauthorized animals and monitoring pet activities within designated areas. The system can include a processor and a camera coupled to a sound emitting device and a light emitting device. The system can capture visual data to analyze the presence and behavior of animals and determine if an animal is a trespassing animal or a pet. The system can distinguish between permitted pets engaging in authorized or unauthorized activities. The system can couple the camera with the light-emitting device and sound-emitting device to act as deterrents when activated. The processor can analyze visual data from the camera to make real-time decisions about the presence of animals. The system can selectively employ light and sound emissions tailored to deter the specific behavior or presence detected. This approach can offer a humane, efficient, and automated solution to the challenges of managing animal presence in various environments, ensuring safety, protecting property, and maintaining the desired order without constant human intervention.

A system can include a camera, light emitting device, sound emitting device, and processor. The camera can capture visual data of an area. The processor can be in communication with the camera, the sound emitting device, and the light emitting device. The processor can analyze the visual data to detect presence of an animal within the area; determine, based on the analysis, whether the animal is a trespassing animal; and responsive to determining that the animal is a trespassing animal or is pet engaging in the unauthorized activity activate the sound emitting device to emit a sound or the light emitting device to emit a light selected to deter the trespassing animal or pet engaging in the unauthorized activity.

### BRIEF DESCRIPTION OF THE DRAWINGS

The accompanying drawings constitute a part of this specification, illustrate an embodiment, and, together with the specification, explain the subject matter of the disclosure.

FIG. 1 is a block diagram of a system, according to an embodiment.

FIG. 2A illustrates an example of a camera, according to an embodiment.

FIG. 2B illustrates an example of a camera, according to an embodiment.

FIG. 3 is a block diagram of a system for a camera that can detect a trespassing animal, according to an embodiment.

FIG. 4 is a block diagram of a system for a camera that can detect an unauthorized pet activity in an outdoor environment, according to an embodiment.

FIG. 5 is a block diagram of a system for a camera that can detect an unauthorized pet activity in an indoor environment, according to an embodiment.

FIG. 6. is a flow diagram of a method for a camera that can detect a trespassing animal or unauthorized pet activity, according to an embodiment.

### DETAILED DESCRIPTION

Disclosed herein are systems and methods for a camera that can detect a trespassing animal or unauthorized pet activity. Reference will now be made to the embodiments illustrated in the drawings, and specific language will be used here to describe the same. It will nevertheless be understood that no limitation of the scope of the disclosure is thereby intended. Alterations and further modifications of the features illustrated here, and additional applications of the principles as illustrated here, which would occur to a person skilled in the relevant art and having possession of this disclosure, are to be considered within the scope of the disclosure.

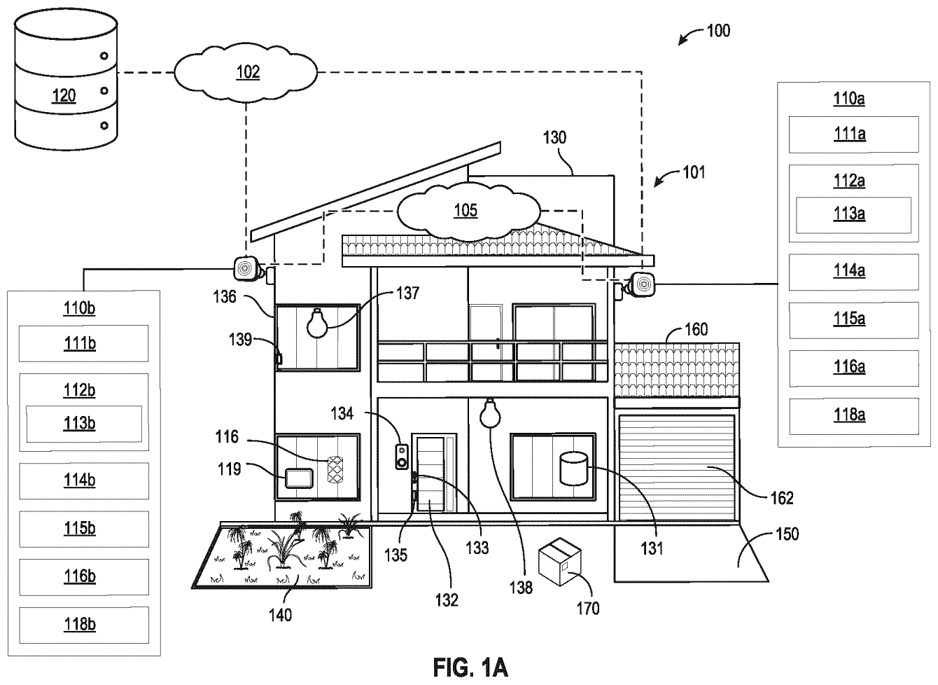

Though various configurations may be utilized to employ these embodiments, the description below shows an example environment of a building in FIG. 1.

FIG. 1 illustrates an example environment 100, such as a residential property, in which the present systems and methods may be implemented. The environment 100 may include a site that can include one or more structures, any of which can be a structure or building 130, such as a home, office, warehouse, garage, and/or the like. The building 130 may include various entryways, such as one or more doors 132, one or more windows 136, and/or a garage 160 having a garage door 162. The environment 100 may include multiple sites. In some implementations, the environment 100 includes multiple sites, each corresponding to a different property and/or building. In an example, the environment 100 may be a cul-de-sac that includes multiple buildings 130.

A first camera 110a and a second camera 110b, referred to herein collectively as cameras 110, may be disposed at the environment 100, such as outside and/or inside the building 130. The cameras 110 may be attached to the building 130, such as at a front door of the building 130 or inside of a living room. The cameras 110 may communicate with each other over a local network 105. The cameras 110 may communicate with a server 120 over a network 102. The local network 105 and/or the network 102, in some implementations, may each include a digital communication network that transmits digital communications. The local network 105 and/or the network 102 may each include a wireless network, such as a wireless cellular network, a local wireless network, such as a Wi-Fi network, a Bluetooth® network, a near-field communication (“NFC”) network, an ad hoc network, and/or the like. The local network 105 and/or the network 102 may each include a wide area network (“WAN”), a storage area network (“SAN”), a local area network (“LAN”) (e.g., a home network), an optical fiber network, the internet, or other digital communication network. The local network 105 and/or the network 102 may each include two or more networks. The network 102 may include one or more servers, routers, switches, and/or other networking equipment. The local network 105 and/or the network 102 may also include one or more computer readable storage media, such as a hard disk drive, an optical drive, non-volatile memory, RAM, or the like.

The local network 105 and/or the network 102 may be a mobile telephone network. The local network 105 and/or the network 102 may employ a Wi-Fi network based on any one of the Institute of Electrical and Electronics Engineers (“IEEE”) 802.11 standards. The local network 105 and/or the network 102 may employ Bluetooth® connectivity and may include one or more Bluetooth connections. The local network 105 and/or the network 102 may employ Radio Frequency Identification (“RFID”) communications, including RFID standards established by the International Organization for Standardization (“ISO”), the International Electrotechnical Commission (“IEC”), the American Society for Testing and Materials® (ASTM®), the DASH7™ Alliance, and/or EPCGlobal™.

In some implementations, the local network 105 and/or the network 102 may employ ZigBee® connectivity based on the IEEE 802 standard and may include one or more ZigBee connections. The local network 105 and/or the network 102 may include a ZigBee® bridge. In some implementations, the local network 105 and/or the network 102 employs Z-Wave® connectivity as designed by Sigma Designs® and may include one or more Z-Wave connections. The local network 105 and/or the network 102 may employ an ANT® and/or ANT+® connectivity as defined by Dynastream® Innovations Inc. of Cochrane, Canada and may include one or more ANT connections and/or ANT+connections.

The first camera 110a may include an image sensor 115a, a processor 111a, a memory 112a, a depth sensor 114a (e.g., radar sensor 114a), a speaker 116a, and a microphone 118a. The memory 112a may include computer-readable, non-transitory instructions which, when executed by the processor 111a, cause the processor 111a to perform methods and operations discussed herein. The processor 111a may include one or more processors. The second camera 110b may include an image sensor 115b, a processor 111b, a memory 112b, a radar sensor 114b, a speaker 116b, and a microphone 118b. The memory 112b may include computer-readable, non-transitory instructions which, when executed by the processor 111b, cause the processor to perform methods and operations discussed herein. The processor 111a may include one or more processors.

The memory 112a may include an AI model 113a. The AI model 113a may be applied to or otherwise process data from the camera 110a, the radar sensor 114a, and/or the microphone 118a to detect and/or identify one or more objects (e.g., people, animals, vehicles, shipping packages or other deliveries, or the like), one or more events (e.g., arrivals, departures, weather conditions, crimes, property damage, or the like), and/or other conditions. For example, the cameras 110 may determine a likelihood that an object 170, such as a package, vehicle, person, or animal, is within an area (e.g., a geographic area, a property, a room, a field of view of the first camera 110a, a field of view of the second camera 110b, a field of view of another sensor, or the like) based on data from the first camera 110a, the second camera 110b, and/or other sensors.

The memory 112b of the second camera 110b may include an AI model 113b. The AI model 113b may be similar to the AI model 113a. In some implementations, the AI model 113a and the AI model 113b have the same parameters. In some implementations, the AI model 113a and the AI model 113b are trained together using data from the cameras 110. In some implementations, the AI model 113a and the AI model 113b are initially the same but are independently trained by the first camera 110a and the second camera 110b, respectively. For example, the first camera 110a may be focused on a porch and the second camera 110b may be focused on a driveway, causing data collected by the first camera 110a and the second camera 110b to be different, leading to different training inputs for the first AI model 113a and the second AI model 113b. In some implementations, the AI models 113 are trained using data from the server 120. In an example, the AI models 113 are trained using data collected from a plurality of cameras associated with a plurality of buildings. The cameras 110 may share data with the server 120 for training the AI models 113 and/or a plurality of other AI models. The AI models 113 may be trained using both data from the server 120 and data from their respective cameras.

The cameras 110, in some implementations, may determine a likelihood that the object 170 (e.g., a package) is within an area (e.g., a portion of a site or of the environment 100) based at least in part on audio data from microphones 118, using sound analytics and/or the AI models 113. In some implementations, the cameras 110 may determine a likelihood that the object 170 is within an area based at least in part on image data using image processing, image detection, and/or the AI models 113. The cameras 110 may determine a likelihood that an object is within an area based at least in part on depth data from the radar sensors 114, a direct or indirect time of flight sensor, an infrared sensor, a structured light sensor, or other sensor. For example, the cameras 110 may determine a location for an object, a speed of an object, a proximity of an object to another object and/or location, an interaction of an object (e.g., touching and/or approaching another object or location, touching a car/automobile or other vehicle, touching or opening a mailbox, leaving a package, leaving a car door open, leaving a car running, touching a package, picking up a package, or the like), and/or another determination based at least in part on depth data from the radar sensors 114.

The sensors, such as cameras 110, radar sensors 114, microphones 118, door sensors, window sensors, or other sensors, may be configured to detect occupancy. For example, the microphones 118 may be configured to sense sounds, such as voices, broken glass, door knocking, or otherwise, and an audio processing system may be configured to process the audio so as to determine whether the captured audio signals are indicative of the presence of a person in the environment 100 or structure 130.

A user interface 119 may be installed or otherwise located at the building 130. The user interface 119 may be part of or executed by a device, such as a mobile phone, a tablet, a laptop, wall panel, or other device. The user interface 119 may connect to the cameras 110 via the network 102 or the local network 105. The user interface 119 may allow a user to access sensor data of the cameras 110. In an example, the user interface 119 may allow the user to view a field of view of the image sensors 115 and hear audio data from the microphones 118. In an example, the user interface may allow the user to view a representation, such as a point cloud, of radar data from the radar sensors 114. The user interface 119 may allow a user to provide input to the cameras 110. In an example, the user interface 119 may allow a user to speak or otherwise provide sounds using the speakers 116.

In some implementations, the cameras 110 may receive additional data from one or more additional sensors, such as a door sensor 135 of the door 132, an electronic lock 133 of the door 132, a doorbell camera 134, and/or a window sensor 139 of the window 136. The door sensor 135, the electronic lock 133, the doorbell camera 134 and/or the window sensor 139 may be connected to the local network 105 and/or the network 102. The cameras 110 may receive the additional data from the door sensor 135, the electronic lock 133, the doorbell camera 134 and/or the window sensor 139 from the server 120.

In some implementations, the cameras 110 may determine separate and/or independent likelihoods that an object is within an area based on data from different sensors (e.g., processing data separately, using separate machine learning and/or other artificial intelligence, using separate metrics, or the like). The cameras 110 may combine data, likelihoods, determinations, or the like from multiple sensors such as image sensors 115, the radar sensors 114, and/or the microphones 118 into a single determination of whether an object is within an area (e.g., in order to perform an action relative to the object 170 within the area. For example, the cameras 110 and/or each of the cameras 110 may use a voting algorithm and determine that the object 170 is present within an area in response to a majority of sensors of the cameras and/or of each of the cameras determining that the object 170 is present within the area. In some implementations, the cameras 110 may determine that the object 170 is present within an area in response to all sensors determining that the object 170 is present within the area (e.g., a more conservative and/or less aggressive determination than a voting algorithm). In some implementations, the cameras 110 may determine that the object 170 is present within an area in response to at least one sensor determining that the object 170 is present within the area (e.g., a less conservative and/or more aggressive determination than a voting algorithm).

The cameras 110, in some implementations, may combine confidence metrics indicating likelihoods that the object 170 is within an area from multiple sensors of the cameras 110 and/or additional sensors (e.g., averaging confidence metrics, selecting a median confidence metric, or the like) in order to determine whether the combination indicates a presence of the object 170 within the area. In some embodiments, the cameras 110 are configured to correlate and/or analyze data from multiple sensors together. For example, the cameras 110 may detect a person or other object in a specific area and/or field of view of the image sensors 115 and may confirm a presence of the person or other object using data from additional sensors of the cameras 110 such as the radar sensors 114 and/or the microphones 118, confirming a sound made by the person or other object, a distance and/or speed of the person or other object, or the like. The cameras 110, in some implementations, may detect the object 170 with one sensor and identify and/or confirm an identity of the object 170 using a different sensor. In an example, the cameras detect the object 170 using the image sensor 115a of the first camera 110a and verifies the object 170 using the radar sensor 114b of the second camera 110b. In this manner, in some implementations, the cameras 110 may detect and/or identify the object 170 more accurately using multiple sensors than may be possible using data from a single sensor.

In some implementations, the cameras 110 may monitor one or more objects based on a combination of data and/or determinations from the multiple sensors (e.g., the cameras 110 or microphones).

The environment 100 may include one or more regions of interest, which each may be a given area within the environment. A region of interest may include the entire environment 100, an entire site within the environment, or an area within the environment. A region of interest may be within a single site or multiple sites. A region of interest may be inside of another region of interest. In an example, a property-scale region of interest which encompasses an entire property within the environment 100 may include multiple additional regions of interest within the property.

The environment 100 may include a first region of interest 140 and/or a second region of interest 150. The first region of interest 140 and the second region of interest 150 may be determined by the AI models 113, fields of view of the image sensors 115 of the cameras 110, fields of view of the radar sensors 114, and/or user input received via the user interface 119. In an example, the first region of interest 140 includes a garden or other landscaping of the building 130 and the second region of interest 150 includes a driveway of the building 130. In some implementations, the first region of interest 140 may be determined by user input received via the user interface 119 indicating that the garden should be a region of interest and the AI models 113 determining where in the fields of view of the sensors of the cameras 110 the garden is located. In some implementations, the first region of interest 140 may be determined by user input selecting, within the fields of view of the sensors of the cameras 110 on the user interface 119, where the garden is located. Similarly, the second region of interest 150 may be determined by user input indicating, on the user interface 119, that the driveway should be a region of interest and the AI models 113 determining where in the fields of view of the sensors of the cameras 110 the driveway is located. In some implementations, the second region of interest 150 may be determined by user input selecting, on the user interface 119, within the fields of view of the sensors of the cameras 110, where the driveway is located.

In a further embodiment, the cameras 110 may perform, initiate, or otherwise coordinate, a welcoming action and/or another predefined action in response to recognizing a known human (e.g., an identity matching a profile of an occupant or known user in a library, based on facial recognition, based on bio-identification, or the like) such as executing a configurable scene for a user, activating lighting, playing music, opening or closing a window covering, turning a fan on or off, locking or unlocking a door 102, lighting a fireplace, powering an electrical outlet, turning on or play a predefined channel or video or music on a television or other device, starting or stopping a kitchen appliance, starting or stopping a sprinkler system, opening or closing a garage door 103, adjusting a temperature or other function of a thermostat or furnace or air conditioning unit, or the like. In response to detecting a presence of a known human, one or more safe behaviors and/or conditions, or the like, in some embodiments, the cameras 110 may extend, increase, pause, toll, and/or otherwise adjust a waiting/monitoring period after detecting a human, before performing a deter action, or the like.

In some implementations, the cameras 110 may receive a notification from a user's smart phone that the user is within a predefined proximity or distance from the home, e.g., on their way home from work. Accordingly, the cameras 110 may activate a predefined or learned comfort setting for the home, including setting a thermostat at a certain temperature, turning on certain lights inside the home, turning on certain lights on the exterior of the home, turning on the television, turning a water heater on, and/or the like.

The security system 101 and/or the one or more security devices, in some implementations, may escalate and/or otherwise adjust an action over time and/or may perform a subsequent action in response to determining (e.g., based on data and/or determinations from one or more sensors, from the multiple sensors, or the like) that the object 170 (e.g., a human, an animal, vehicle, drone, etc.) remains in an area after performing a first action (e.g., after expiration of a timer, or the like).

In some implementations, the cameras 110 and/or the server 120 (or other device), may include image processing capabilities and/or radar data processing capabilities for analyzing images, videos, and/or radar data that are captured with the cameras 110. The image/radar processing capabilities may include object detection, facial recognition, gait detection, and/or the like. For example, the controller 106 may analyze or process images and/or radar data to determine that a package is being delivered at the front door/porch. In other examples, the cameras 110 may analyze or process images and/or radar data to detect a child walking within a proximity of a pool, to detect a person within a proximity of a vehicle, to detect a mail delivery person, to detect animals, and/or the like. In some implementations, the cameras 110 may utilize the AI models 113 for processing and analyzing image and/or radar data.

In some implementations, the security system 101 and/or the one or more security devices are connected to various IoT devices. As used herein, an IoT device may be a device that includes computing hardware to connect to a data network and to communicate with other devices to exchange information. In such an embodiment, the cameras 110 may be configured to connect to, control (e.g., send instructions or commands), and/or share information with different IoT devices. Examples of IoT devices may include home appliances (e.g., stoves, dishwashers, washing machines, dryers, refrigerators, microwaves, ovens, coffee makers), vacuums, garage door openers, thermostats, HVAC systems, irrigation/sprinkler controller, television, set-top boxes, grills/barbeques, humidifiers, air purifiers, sound systems, phone systems, smart cars, cameras, projectors, and/or the like. In some implementations, the cameras 110 may poll, request, receive, or the like information from the IoT devices (e.g., status information, health information, power information, and/or the like) and present the information on a display and/or via a mobile application.

The IoT devices may include a smart home device 131. The smart home device 131 may be connected to the IoT devices. The smart home device 131 may receive information from the IoT devices, configure the IoT devices, and/or control the IoT devices. In some implementations, the smart home device 131 provides the cameras 110 with a connection to the IoT devices. In some implementations, the cameras 110 provide the smart home device 131 with a connection to the IoT devices. The smart home device 131 may be an AMAZON ALEXA device, an AMAZON ECHO, A GOOGLE NEST device, a GOOGLE HOME device, or other smart home hub or device. In some implementations, the smart home device 131 may receive commands, such as voice commands, and relay the commands to the cameras 110. In some implementations, the cameras 110 may cause the smart home device 131 to emit sound and/or light, speak words, or otherwise notify a user of one or more conditions via the user interface 119.

In some implementations, the IoT devices include various lighting components including the interior light 137, the exterior light 138, the smart home device 131, other smart light fixtures or bulbs, smart switches, and/or smart outlets. For example, the cameras 110 may be communicatively connected to the interior light 137 and/or the exterior light 138 to turn them on/off, change their settings (e.g., set timers, adjust brightness/dimmer settings, and/or adjust color settings).

In some implementations, the IoT devices include one or more speakers within the building. The speakers may be stand-alone devices such as speakers that are part of a sound system, e.g., a home theatre system, a doorbell chime, a Bluetooth speaker, and/or the like. In some implementations, the one or more speakers may be integrated with other devices such as televisions, lighting components, camera devices (e.g., security cameras that are configured to generate an audible noise or alert), and/or the like. In some implementations, the speakers may be integrated in the smart home device 131.

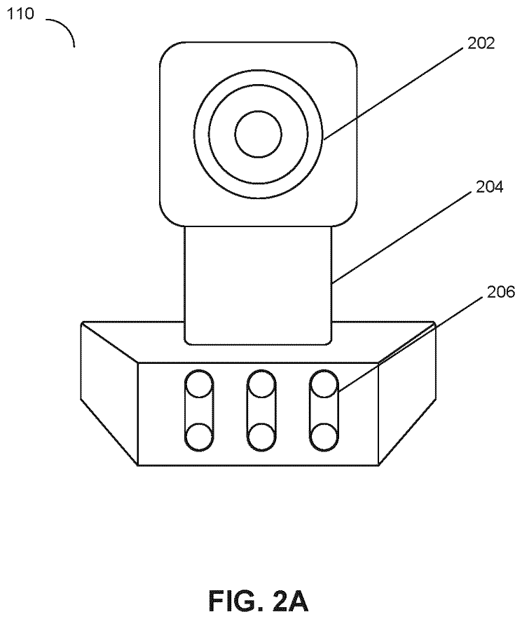

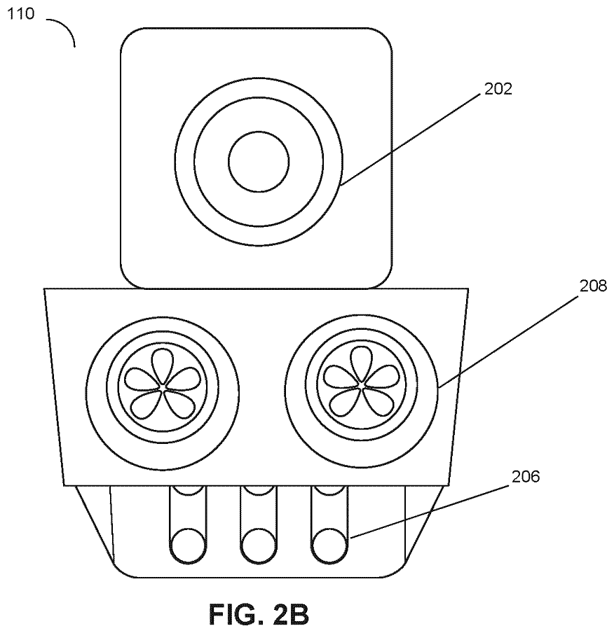

FIGS. 2A-2B depict various views of camera 110. The camera 110 can include a lens 202, mount 204, light emitting device 206, sound emitting device 208 and/or processors. The lens 202 can be the optical component responsible for capturing visual data. The mount 204 can be the support structure of the camera 110. The light emitting device 206 can project light and provide illumination. The sound emitting device 208 can be responsible for emitting sounds.

The camera can include more than one lens 202. The lens 202 can provide high-resolution imaging capabilities of the camera and can allow the camera 110 to monitor an area. The lens 202 can include a wide-angle lens, enabling the camera 110 to capture a broader field of view and monitor large areas with a single camera. The lens 202 can adjust the focal length the zoom level that can allow the camera 110 to focus on areas of interest within a larger space. The lens 202 can include an infrared lens that can capture images in low-light conditions by using infrared light. The lens can capture panoramic or hemispherical image to allow for complete area surveillance with minimal blind spots.

The mount 204 can allow the camera 110 to rotate or pivot to cover a wide range of angles and areas. The mount 204 can securely attach the camera 110 to various surfaces including walls, ceilings, or poles.

The light emitting device 206 can provide illumination to allow the camera 110 to capture images or video (e.g., under low-light conditions, nighttime surveillance, etc.). The light emitting device 206 can include adjustable intensity levels and light in various colors (e.g., LED lights). The light emitting device 206 can be a visual deterrent to discourage unauthorized animals or intruders from entering an area. For example, the light emitting device 206 can include strobe features such as emitting rapid flashes of light that disorient and deter animals or trespassers. The memory 112 can include light profiles (e.g., light intensity, color, pattern, flashes, and/or duration) that can deter specific animals or for use in different scenarios. Animals can react differently to various light profiles. For example, some may be deterred by intense white light, while others may find flashing lights or specific colors (like red or blue) unsettling.

In some implementations, the memory 112 can include a library of sounds. The library of sounds can include sound files that can deter specific animals or for use in different scenarios. The library of sounds can include ultrasonic frequencies that can be tailored to the hearing sensitivities of different species, from rodents to larger mammals. Users can upload their own sound files to the library of sounds in the memory 112 (e.g., to upload familiar auditory cues for pets).

The sound emitting device 208 can be the speaker 116. The sound emitting device 208 can act as an audible alarm and can emit loud and startling sounds to deter trespassing animals or to alert nearby individuals of a potential security breach. The sound emitting device 208 can include ultrasonic speakers. The sound emitting device 208 can access the library of sounds that can be customized according to the type of animal detected or the situation (e.g., high-pitched frequencies that are uncomfortable for certain animals to audible warnings for humans). The sound emitting device 208 can emit sounds at different frequencies, some of which may be inaudible to humans but effective at deterring wildlife or pets. The sound emitting device 208 can include adjustable volume settings to modulate the loudness of the emitted sound (e.g., based on the time of day or the surrounding environment). The sound emitting device 208 can emit pre-recorded or synthesized voice messages to provide instructions for pets.

In some implementations, the sound emitting device 208 can automatically select and emit different sounds based on the type of animal detected by the camera 110 analysis. To prevent animals from becoming accustomed to any one sound, the sound emitting device 208 can play sounds in a sequence or randomly to maintain the element of surprise and enhance the deterrent effect.

The AI model 113 can be exposed and pre-trained to a dataset of animal images and videos. The AI model 113 can learn and recognize animal features and characteristics, and can identify different animal species within the camera 110 field of view. The training can teach the AI model 113 to differentiate between species, sizes, and other. The AI model 113 can also learn different animal and sound deterrents. The AI model 113 can be periodically or continuously trained through feedback loops. The AI model 113 can be trained to identify the sound file from the library of sounds that deters each animal species. The AI model 113 can be trained to identify the light profile from the memory 112 that deters each animal species.

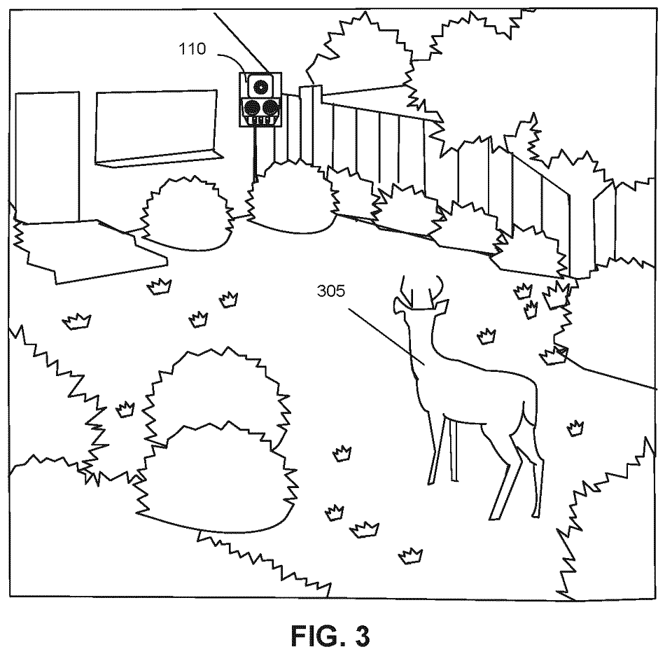

FIG. 3 depicts camera 110 that can detect a trespassing animal 305. The camera 110 can be positioned in an outdoor environment (e.g., garden, backyard, garage, etc.) to monitor an area. The camera 110, via the AI model 113, can identify the presence of an animal 305. The camera 110, via the visual/image data (e.g., from image sensor 115) and the AI model 113, can categorize and/or classify the animal 305 as a trespassing animal or a pet. For example, the animal 305 can be a trespassing animal such as a deer. When the presence of the trespassing animal 305 is detected, the light emitting device 206 and/or the sound emitting device 208 can be activated to deter the trespassing animal 305.

When the camera 110, via the AI model 113, classifies an animal 305 as a trespassing animal 305, the camera 110 can engage in deterrent measures to encourage trespassing animal 305 to vacate the area. The deterrents are activated based on the type of animal identified by the AI model 113 and the behavior it is exhibiting. For example, if the AI model 113 recognizes the trespassing animal 305 as a deer, a species known to respond to visual deterrents, the camera 110 system can trigger the light emitting device 206 to project a series of bright flashing lights. In another example, if the AI model 113 recognizes the trespassing animal 305 as a raccoon which have sensitive hearing, the AI model 113 may determine an ultrasonic frequency that can deter the raccoon. The sound emitting device 208 can emit the ultrasonic frequency that deters raccoons but that can be inaudible to humans, thereby avoiding disturbance to the neighborhood.

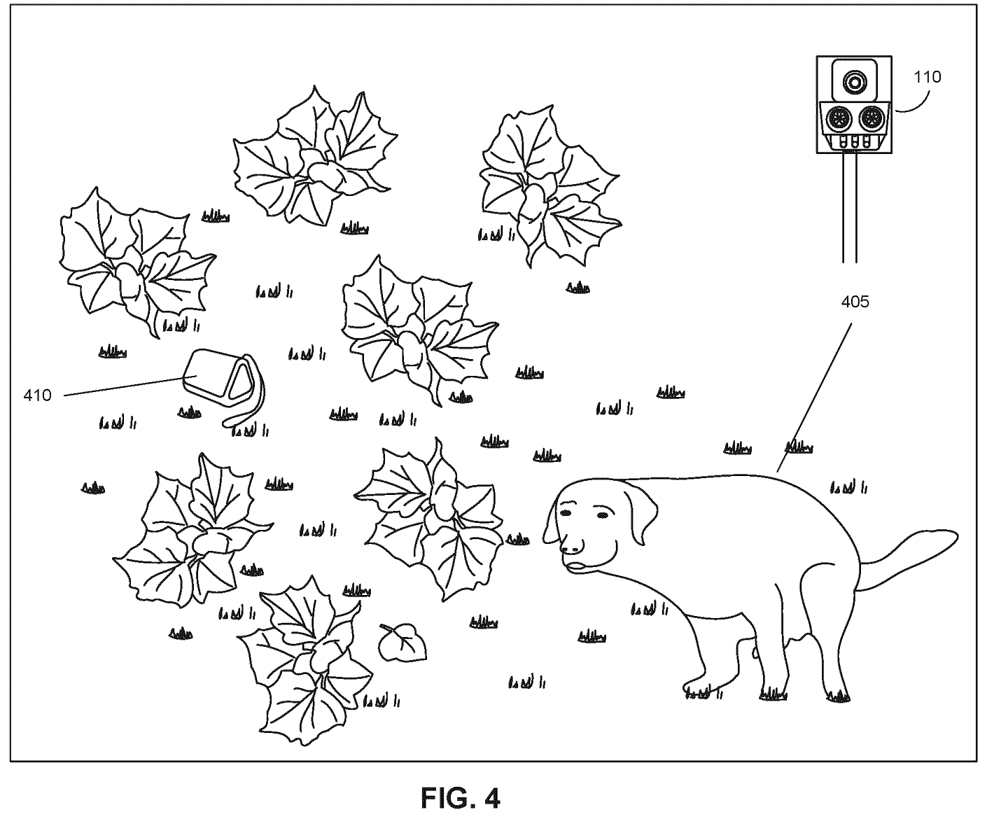

FIG. 4 depicts camera 110 that can detect an unauthorized pet activity in an outdoor environment. The camera 110, via the visual/image data (e.g., from image sensor 115) and the AI model 113, can identify the presence of an animal 405. The camera 110, via the AI model 113, can categorize and/or classify the animal 405 as a trespassing animal or pet. For example, the animal 405 can be a dog 405. The camera 110, via the AI model 113, can identify the dog 405 as a pet of the houseowners. The camera 110, the via visual/image data (e.g., from image sensor 115) and the AI model 113, can identify an unauthorized behavior by the pet dog 405. Unauthorized behavior by the pet can include digging in a flowerbed, entering a restricted area, defecating in a prohibited area, excessive barking, or being overly aggressive. When the unauthorized behavior is detected, the light emitting device 206 and/or the sound emitting device 208 can be activated to deter the pet unauthorized behavior. The AI model 113 can learn from the pet 405 reactions to different messages, sounds, and/or light and the AI model 113 can adapt its response to the most effective deterrent for the pet 405.

The camera 110 and the camera 110 components may transmit information and data to the user interface 119 (e.g., user device) via hardware and/or network protocols such as local networks (e.g., Wi-Fi or Ethernet), wireless capabilities, Real Time Streaming Protocol (RTSP), WebRTC, and the like. The camera 110 may transmit information and data to a cloud server, from where the user interface 119 can access the transmitted information and data. The user interface 119 may connect to the cameras 210 and user devices (smart phone, tablet, computer, smart home device 131, etc.) via the network 102 or the local network 105 with wireless or wired connectivity. The camera 110 can transmit information and data to the user interface 119.

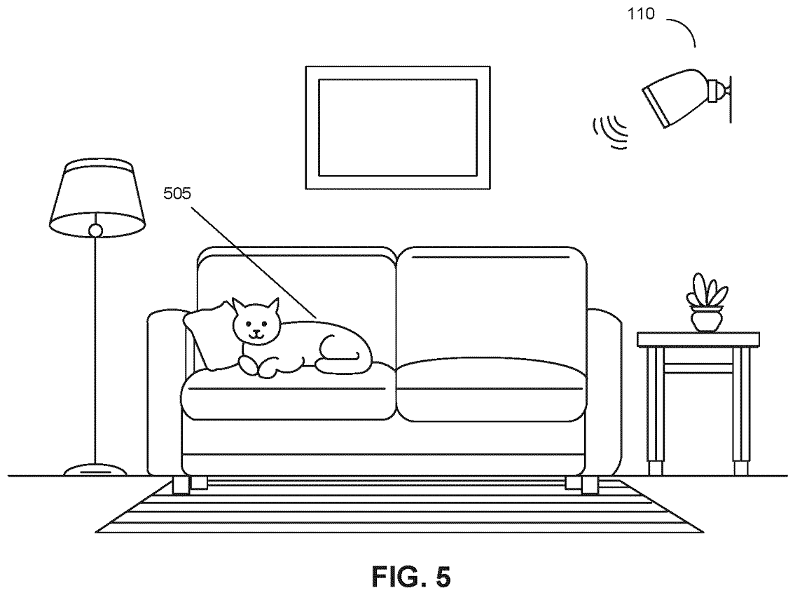

FIG. 5 depicts camera 110 that can detect an unauthorized pet activity in an indoor environment. The camera 110, via the visual/image data (e.g., from image sensor 115) and the AI model 113, can identify the presence of an animal 505. The animal 505 can be a pet cat 505. The camera 110, via visual/image data (e.g., from image sensor 115) and the AI model 113, can identify an unauthorized behavior by the cat 505. Unauthorized behavior by the pet can include scratching furniture, climbing on furniture, chewing on wires, sitting on furniture, defecating, etc. When the unauthorized behavior is detected, the light emitting device 206 and/or the sound emitting device 208 can be activated to deter the pet unauthorized behavior. For example, when the camera 110 detects an unauthorized activity, such as the pet 505 being on the couch if that is against the household rules, the sound emitting device 208 can emit a pre-recorded message from the homeowner stating, “Get off the couch”. The sound emitting device 208 can emit sounds that deter pets, encouraging them to stop the unwanted behavior. The AI model 113 can learn from the pet 505 reactions to different messages, sounds, and/or light and the AI model 113 can adapt its response to the most effective deterrent for the pet 505. The camera 110 can record video data of the pet engaging in the unauthorized activity and transmit the recorded video to a device of a user.

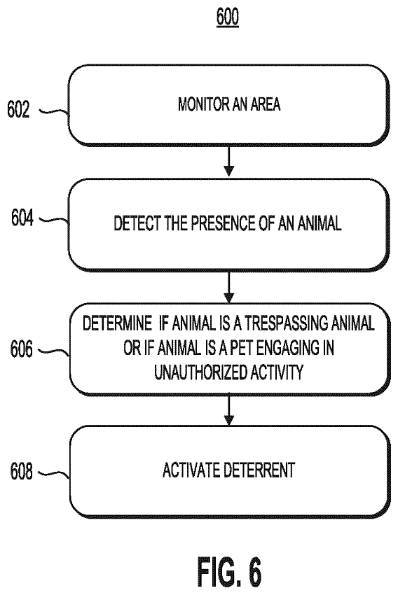

FIG. 6 depicts a flow diagram of a method 600 method for a camera that can detect a trespassing animal or unauthorized pet activity. The method 600 may be implemented using any one or more of the components and devices detailed herein. Additional, fewer, or different operations may be performed in the method 600 depending on the embodiment. For example, the method 600 may include example operations associated with one or more camera 110, which may be examples of the corresponding devices described with reference to FIGS. 1-5. In brief overview of the method 600, a camera (e.g., the camera 110, etc.) can monitor an area and capture audio data and visual data (step 602). The camera can include one or more processors coupled with non-transitory memory that can, by analyzing visual data captured by the camera, detect the presence of an animal (step 604), determine if the animal is a trespassing animal or if animal is a pet engaging in unauthorized activity (step 606), and activate deterrents (step 608).

At step 602, the method 600 may include a camera continuously monitoring a designated area. The area can be indoors, like a living room, or outdoors, such as a garden or backyard. The monitoring process can include capturing real-time audio and visual data. The camera can be equipped with one or more processors and coupled with non-transitory memory to facilitate constant surveillance.

At step 604, upon the camera's capturing of audio and visual data, the camera can analyze the data to detect the presence of an animal. The camera can utilize machine learning models and AI models (such as AI model 113) or other algorithms capable of distinguishing animal forms and movements from the surrounding environment.

At step 606, once an animal is detected, the method 600 can continue with the differentiation process. The camera can determine if the detected animal is trespassing animal (e.g., wild animal, snake, raccoons, deer, or a neighborhood pet wandering into the area) or a household pet. The camera can determine if the household pet is engaging in unauthorized activity.

At step 608, the method 600 can include the camera activating/initiating deterrents upon confirmation of trespassing animal or a pet engaging in unauthorized activity. The type of deterrent activated can include audible alarm, spoken command, burst of light, ultrasonic sound. The type of deterrent activated can pre-selected based on the type of animal and/or the unauthorized activity detected. The deterrent can be include a light emitting device 206 and/or sound emitting device 208.

The foregoing method descriptions and the process flow diagrams are provided merely as illustrative examples and are not intended to require or imply that the steps of the various embodiments must be performed in the order presented. The steps in the foregoing embodiments may be performed in any order. Words such as “then” and “next,” among others, are not intended to limit the order of the steps; these words are simply used to guide the reader through the description of the methods. Although process flow diagrams may describe the operations as a sequential process, many of the operations can be performed in parallel or concurrently. In addition, the order of the operations may be rearranged. A process may correspond to a method, a function, a procedure, a subroutine, a subprogram, and the like. When a process corresponds to a function, the process termination may correspond to a return of the function to a calling function or a main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, among others, may be passed, forwarded, or transmitted via any suitable means including memory sharing, message passing, token passing, network transmission, etc.

The actual software code or specialized control hardware used to implement these systems and methods is not limiting. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A system, comprising:
a camera configured to capture visual data of an area;
a light emitting device that is coupled to the camera;
a sound emitting device that is coupled to camera and the light emitting device; and
a processor in communication with the camera, the sound emitting device, and the light emitting device, wherein the processor is configured to:
analyze the visual data to detect presence of an animal within the area;
determine, based on the analysis, whether the animal is a pet engaging in an unauthorized activity; and
responsive to determining that the animal is the pet engaging in the unauthorized activity:
activate the sound emitting device to emit a sound selected to deter the pet engaging in the unauthorized activity; or
activate the light emitting device to emit a light specifically selected to deter the pet engaging in the unauthorized activity.

2. The system of claim 1, wherein the processor is further configured to record video data of the animal and transmit the recorded video to a device of a user.

3. The system of claim 1, wherein at least one of the light or the sound is selected from a library based on the animal.

4. The system of claim 1, where in the light or the sound is selected from a library based on the unauthorized activity.

5. The system of claim 1, wherein the sound is ultrasonic relative to human hearing range.

6. The system of claim 1, wherein the sound is infrasonic relative to human hearing range.

7. The system of claim 1, wherein the sound or the light is emitted with a characteristic selected as corresponding a type of the animal within the area.

8. A system, comprising:
a camera configured to capture visual data of an area;
a light emitting device that is coupled to the camera;
a sound emitting device that is coupled to camera and the light emitting device; and
a processor in communication with the camera, the sound emitting device, and the light emitting device, wherein the processor is configured to:
analyze the visual data to detect presence of an animal within the area;
determine, based on the analysis, whether the animal is a pet engaging in an unauthorized activity; and
responsive to determining that the animal is the pet engaging in the unauthorized activity,
activate the sound emitting device to emit a sound selected to deter the pet engaging in the unauthorized activity; or
activate the light emitting device to emit a light selected to deter the pet from engaging in the unauthorized activity.

9. The system of claim 8, wherein the processor is further configured to record video data of the animal and transmit the recorded video to a device of a user.

10. The system of claim 8, wherein at least one of the light or the sound is selected from a library based on the animal.

11. The system of claim 8, where in the light or the sound is selected from a library based on the unauthorized activity.

12. The system of claim 8, wherein the sound is ultrasonic relative to human hearing range.

13. The system of claim 8, wherein the sound is infrasonic relative to human hearing range.

14. The system of claim 8, wherein the sound or the light is emitted with a characteristic selected as corresponding a type of the animal within the area.

15. A method comprising:
analyzing visual data captured by a camera to detect a presence of an animal within the area;
determining, based on the analysis of the visual data, whether the animal is a trespassing animal; and
activating at least one of a sound emitting device to emit a sound selected to deter the trespassing animal or a light emitting device to emit a light selected to deter the trespassing animal.

16. The system of claim 15, further comprising recording video data of the animal and transmitting the recorded video to a device of a user.

17. The system of claim 15, wherein at least one of the light or the sound is selected from a library based on the animal.

18. The system of claim 15, where in the light or the sound is selected from a library based on an unauthorized activity of the animal.

19. The system of claim 15, wherein the sound is ultrasonic relative to human hearing range.

20. The system of claim 15, wherein the sound or the light is emitted with a characteristic selected as corresponding a type of the animal within the area.
